(19) United States
(12) Patent Application Publication
(10) Pub. No.: US 2006/0090092 A1
(43) Pub. Date: Apr. 27, 2006

(54) Clock timing adjustment

(76) Inventor: Anton H. Verhulst, Tewksbury, MA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/973,026

(22) Filed: Oct. 25, 2004

(51) Int. Cl. G06F 1/12

(52) U.S. Cl. 713/400

(57) ABSTRACT

Apparatus and methods are provided for clock timing adjustment. One embodiment of a computing device, the device includes first processor, a memory in communication with the first processor. The device includes computer executable instructions stored in memory and executable on the first processor to identify a clock speed for a first processor. Computer executable instructions also execute to identify clock speed for a second processor and to adjust a stream of clock interrupts generated by the second processor such that the clock speed of the second processor is synchronized to the clock speed of the first processor.

### INTRODUCTION

Many computing devices and systems include more than one processor to provide a variety of functionality to the users of the device or system. These devices and systems are often referred to as multiprocessor systems or devices. In such multiprocessor systems and devices, computer executable instructions are executed by the multiple processors to provide the variety of functions.

Since these systems and devices have multiple processors available to handle the various tasks, different tasks or portions thereof can be assigned to each of the various processors. In this way, tasks can be accomplished more quickly and/or more tasks can be handled at once.

In order to organize the work flow, each of the processors uses a clock that can be used, for example, as a frame of reference for timing the sending and receiving of information. The clock can also be used for the initiation of various tasks and to measure the amount of time to wait for a response to a request for information, among other functions.

The speed of the clock can be different for different processors. Clock speed as defined herein is the number of clock cycles within a given increment of time. For example, one processor can have a clock speed of 400 cycles per second and another clock can have a speed of 1200 cycles per second. In many multiprocessor systems and devices, each processor within the system or device can have different clock speeds. When information is past between processors having different, or mixed, clock speeds, the difference in the number of clock cycles can create incorrect results.

The interval timer provides timing functionality to application programs by sending interval timer interrupts periodically at a particular interval rate or frequency. For example, the clock speed can be used as a base for an interval timer. The interval timer rate is used by an operating system of a computing device or system to initialize system wide global parameters such as: the number of interval timer interrupts per second (some of ordinary skill in the art refer to this quantity as hz), and the number of milliseconds (ms) per interval timer interrupt (some of ordinary skill in the art refer to these as “ticks”). These global parameters can be used in a variety of computing functions.

For example, global parameters are used to set timeouts. Timeouts are often used to end an incomplete task when the timeout is executed by a processor. For instance, if an action has not occurred in a specified amount of time, the timeout can direct the computing device to end the waiting loop so that the request can be reinitiated or terminated. Timeouts are used to free up a line or port that is tied up with a request that has not been answered within a reasonable amount of time. For each situation in which a timeout is used there is a default length of time before the timeout is initiated. With respect to timeouts, the interval timer is used to set the amount of time before a timeout is to be sent.

When an interval timer interrupt occurs, the kernel also increments per processor counters as a measurement of the time the processor has spent executing in user space, system (kernel) space, idling, and/or waiting for I/O functions to complete. In the past, the frequency of the interval timer interrupts remained constant with respect to different processors, even if the processor clock speeds were different. However, in some computing devices and systems, the clock and the interval timer are now driven by the same oscillator. In such cases, if the processor speeds of two processors are different, their interval timer frequencies will also be different. In this way, not only does the device or system have mixed speed processors, but it also has mixed speed interval timers.

When per processor interval timer interrupts arrive at the kernel at different rates, statistics keeping, processor scheduling, kernel process timeouts, and other such functions, can be adversely affected because the kernel assumes that there is one device or system wide interval timer frequency. In addition, some kernel loadable subsystems use these global parameters and per processor counters and, in some cases, when presented with mixed interval timer frequency, these subsystems may have difficulty producing correct results.

The values of hz and per processor counters can also be exported to user space via several APIs and, therefore, application and operating system programs can be affected through use of the exported information.

### BRIEF DESCRIPTION OF THE DRAWINGS

FIG. 1 illustrates an example of a multiprocessor computing device.

FIG. 2 illustrates an exemplary multiprocessor system.

FIG. 3 illustrates an exemplary multiprocessor system including a number of localities.

FIG. 4 illustrates an example of how streams of interrupts can be adjusted and passed between a number of processors and a number of application programs.

### DETAILED DESCRIPTION

Embodiments of the present invention include devices, systems, and methods that provide the kernel and the users with a consistent and uniform interval timer frequency. In various embodiments, this is accomplished by adjusting the number of interval timer interrupts in an interrupt stream before that portion of the interrupt stream is delivered to a clock handler. By adjusting the streams of interrupts of a number of processors, the streams can be synchronized. In this way, the computing system or device can have a consistent timer base.

For instance, if a first processor interrupts 800 times per second and a second processor interrupts at 1000 times per second, 1 in 5 interval timer interrupts for the second processor can be discarded so that the clock handler receives the same number of calls for the second processor as for the first processor in a particular period of time. (i.e., 800 per second, in this example). Likewise, if a second processor is slower than the first processor, we can make additional calls to the clock handler with computer executable instructions to bring the number of clock ticks in a given amount of time (as seen by the system) to the same number as the first processor.

For example, when an interval timer interrupt is detected, the count for the particular processor associated with the interrupt is examined and, if the total accumulated count is higher than the first processor count, the interrupt is discarded. If not, the interrupt continues and clock handler is called. If a second processor is slower than the first processor, computer executable instructions can execute to insert a tick. (i.e., if the total accumulated count of the second processor is less than that of the first processor). In such embodiments, the first processor and other equal speed processor ticks will be passed to the clock handler. If a new processor begins running on the system, in some embodiments, the new processor's speed can be recalculated and the counts can be synchronized at next boot or during runtime.

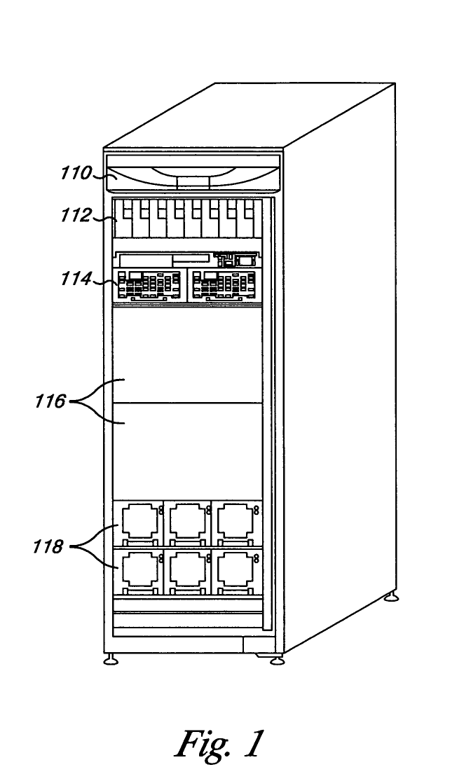

FIG. 1 illustrates an example of a multiprocessor computing device. The computing device 100 includes a user control panel 110, memory 112, a number of Input/Output (I/O) components 114, a number of processors 116, and a number of power supplies 118.

Computing device 100 can be any device that can execute computer executable instructions. For example, computing devices can include desktop personal computers (PCs), workstations, and/or laptops, among others.

A computing device 100 can be generally divided into three classes of components: hardware, operating system, and program applications. The hardware, such as a processor (e.g., one of a number of processors), memory, and I/O components, each provide basic computing resources.

Embodiments of the invention can also reside on various forms of computer readable mediums. Those of ordinary skill in the art will appreciate from reading this disclosure that a computer readable medium can be any medium that contains information that is readable by a computer. For example, the computing device 100 can include memory 112 which is a computer readable medium. The memory included in the computing device 100 can be of various types, such as ROM, RAM, flash memory, and/or other types of volatile and/or nonvolatile memory.

The various types of memory can also include fixed or portable memory components, or combinations thereof For example, memory mediums can include storage mediums such as, but not limited to, hard drives, floppy discs, memory cards, memory keys, optically readable memory, and the like.

Operating systems and/or program applications can be stored in memory. An operating system controls and coordinates the use of the hardware among a number of various program applications executing on the computing device or system. Operating systems are a number of computer executable instructions that are organized in program applications to control the general operation of the computing device. Operating systems include Windows, Unix, and/or Linux, among others, as those of ordinary skill in the art will appreciate.

Program applications, such as database management programs, software programs, business programs, and the like, define the ways in which the resources of the computing device are employed. Program applications are a number of computer executable instructions that process data for a user. For example, program applications can process data for such computing functions as managing inventory, calculating payroll, assembly and management of spreadsheets, word processing, managing network and/or device functions, and other such functions as those of ordinary skill in the art will appreciate from reading this disclosure.

As shown in FIG. 1, embodiments of the present invention can include a number of Input/Output (I/O) components 114. Computing devices can have various numbers of I/O components and each of the I/O components can be of various different types. These I/O components can be integrated into a computing device 100 and/or can be removably attached, such as to an I/O port. For example, I/O components can be connected via serial, parallel, Ethernet, and Universal Serial Bus (USB) ports, among others.

Some types of I/O components can also be referred to as peripheral components or devices. These I/O components are typically removable components or devices that can be added to a computing device to add functionality to the device and/or a computing system. However, I/O components include any component or device that provides added functionality to a computing device or system. Examples of I/O components can be printing devices, scanning devices, faxing devices, memory storage devices, network devices (e.g., routers, switches, buses, and the like), and other such components.

I/O components can also include user interface components such as display devices, including touch screen displays, keyboards and/or keypads, and pointing devices such as a mouse and/or stylus. In various embodiments, these types of I/O components can be used in compliment with the user control panel 110 or instead of the user control panel 110.

In FIG. 1, the computing device 100 also includes a number of processors 116. Processors are used to execute computer executable instructions that make up operating systems and program applications. Processors are used to process computer executable instruction such as interrupts.

According to various embodiments of the invention, a processor can also execute instructions regarding transferring an interrupt from one processor to another, as described herein, and criteria for selecting when to transfer an interrupt. These computer executable instructions can be stored in memory, such as memory 112, for example.

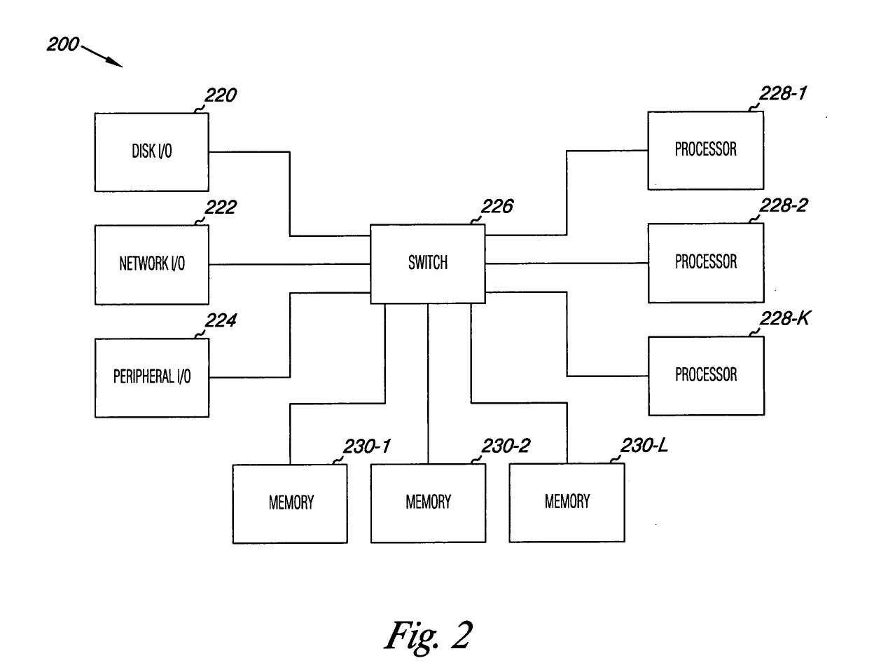

FIG. 2 illustrates an exemplary multiprocessor system. The system 200 of FIG. 2 includes a number of I/O components 220, 222, and 224, a switch 226, a number of processors 228-1 to 228-K, and a number of memory components 230-1 to 230-L.

The designators “K”, “L”, “M”, “N”, “P”, and “Q” are used to indicate that a number of particular components, such as processors, memory, localities, and applications, can be used in embodiments of the present invention. The number that one designator represents can be the same or different from the number represented by another designator. Further, the use of designators for certain components shown should not be viewed as limited to the quantities of the other components shown.

The system 200 of FIG. 2 includes a disk I/O component 220, a network I/O component 222, and a peripheral I/O component 224. The disk I/O component 220 can be used to connect a hard disk to a computing device. The connection between the disk I/O component 220 and processors 228-1 to 228-K allows information to be passed between the disk I/O component and one or more of the processors 228-1 to 228-K.

The embodiment illustrated in FIG. 2 also includes a network I/O component 222. Network I/O components can be used to connect a number of computing and/or peripheral devices within a networked system or to connect one networked system to another networked system. The network I/O component 222 also can be used to connect the networked system 200 to the Internet.

System 200 of FIG. 2 also includes a peripheral I/O component 224. The peripheral I/O component 224 can be used to connect one or more peripheral components to the processors 228-1 to 228-K. For example, a computing system can have fixed or portable external memory devices, printers, keyboards, displays, and other such peripherals connected thereto.

The embodiment of FIG. 2 includes a switch 226, a number of processors 228-1 to 228-K, and a number of memory components 230-1 to 230-L. The switch 226 can be used to direct information between the I/O components 220, 222, and 224, the memory components 230-1 to 230-L, and the processors 228-1 to 228-K. Those of ordinary skill in the art will understand that the functionalities of the switch 226 can be provided by one or more components of a computing device and do not have to be provided by an independent switching device or component as is illustrated in FIG. 2.

Various multiprocessor systems include a single computing device having multiple processors, a number of computing devices each having single processors, or multiple computing devices each having a number of processors. For example, computing systems can include a number of computing devices (e.g., computing device 100 of FIG. 1) that can communicate with each other.

The embodiments of the present invention, for example, can be useful in systems and devices where the processors operate under a single operating system. In such systems and devices, the operating system can monitor the interrupts and can control the transfer thereof to and from the various processors whether located on one device or on multiple devices.

Various embodiments of the present invention can include computer executable instructions to check the processors or clock speed data in memory within the system or device to identify if clock speed synchronization should be implemented. Some advantages of clock adjustment, accomplished according to the various embodiments of the present invention, are that no other kernel work to support mixed speed interval timers should have to be done and that third party vendors and end users of the per processor interval counters should not be affected.

In various computing device and system embodiments, such as that shown in FIG. 2, the computing device or system includes a number of processors and memory in communication with the processors as discussed above. A first processor is designed to interact with a number of other processors, such as a second processor, a third processor, and others.

In some embodiments, the first processor can be selected from a number of processor on the system or device. Those of ordinary skill in the are will appreciate that the selection of the first processor can be accomplished by software firmware or hardware resources. The various processors can be a part of a computing device or can be located on various devices of a computing system.

Computing device or system embodiments also include computer executable instructions stored in memory and executable on one of the number of processors. The computer executable instructions include instructions executable to identify a clock speed for a first processor and a second processor.

In some embodiments, the computer executable instructions to identify a clock speed for a first processor can include accessing a data file having the clock speeds of a number of processors, such as the first processor and/or the second processor. A single data file or multiple data files can be accessed to retrieve clock speed information depending upon how the data structure for storing such information is designed. For example, each processor could have its own data file, a computing device can have a data file with information about each of its processor, or the system could have a data file with information about each of its processors, etc.

The data files can be located in volatile or non-volatile memory and can be located on the computing device of the first processor or on another device in a computing system. The data file(s) can be accessed by a query from the kernel or filtering computer executable instructions. The clock speed information can also be received from a particular processor.

Those of ordinary skill in the art will appreciate from reading this disclosure that the embodiments of the present invention are not constrained to the exemplary devices and systems illustrated in FIGS. 1 and 2 and that other configurations, component orientations, and architectures can be used with the various embodiments disclosed herein.

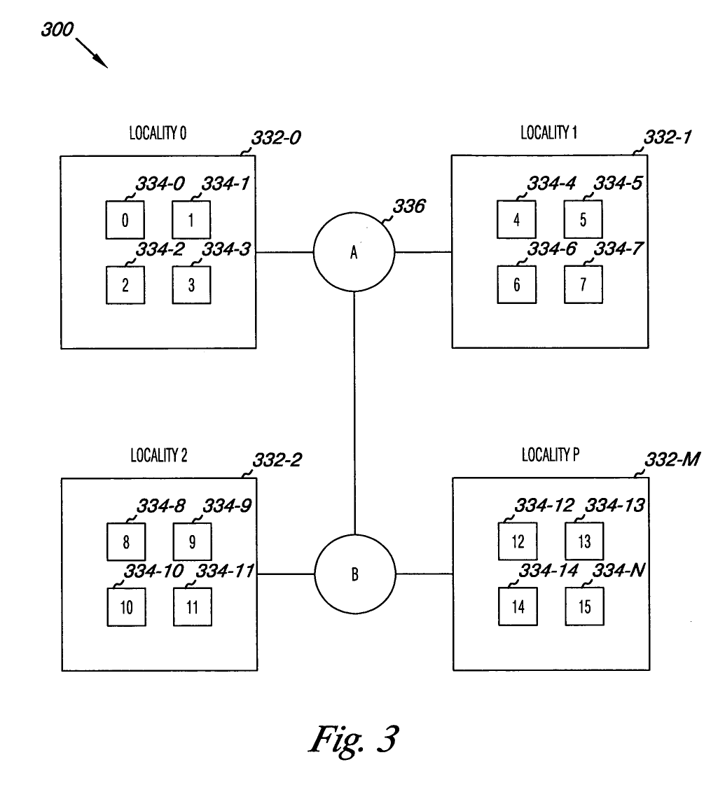

FIG. 3 illustrates another exemplary multiprocessor system including a number of localities. In the embodiment shown in FIG. 3, the system 300 includes four localities (i.e. 0, 1, 2, and M). The localities each contain a number of processors (e.g., four). In system 300, 16 processors 334-0 to 334-N are provided (i.e., 0-15). Since this is a multiprocessor system or device, the processors can be used in parallel to process multiple interrupts at once.

Within the system or device 300, the clock on one of the processors (e.g., 334-0 to 334-N) may be used as the base for timing calculations. In some device or systems, however, the processor clock to be used as the base clock has not been chosen. In such cases, a first processor (sometimes referred to as a master or monarch) can be selected from the number of processors within the various localities. The clock associated with the first processor can then be used as a base for calculations involving the all of the processors within the various localities. That is, the base clock can act as the base for all processor within the system regardless of the locality in which they may reside.

Additionally, the various localities are connected via a number of junctions 336 labeled crossbars A and B. In embodiments of the present invention computer executable instructions such as an application program can be executed on a processor in a first locality (Locality 0 332-0) and the kernel, controlling the delegation of the executing of the application program or portions thereof to the variety of processors of the system, can be located in another locality (Locality 1 332-1). In such cases, a stream of clock interrupts can cross a junction 336, such as from Locality 0 332-0 to Locality 1 332-1, between the locality having processor executing the application program and the locality having the kernel therein.

The individual processors or the processors within the each locality may have different clock speeds. In these instances, a stream of clock interrupts of the second processor (e.g., the processor handling the execution of the application program) can be adjusted to synchronize it to a stream of clock interrupts of the first processor (e.g., the processor executing the kernel). The adjustment can be done either before the portion of the stream to be adjusted has crossed from one processor to another, or after the information has crossed.

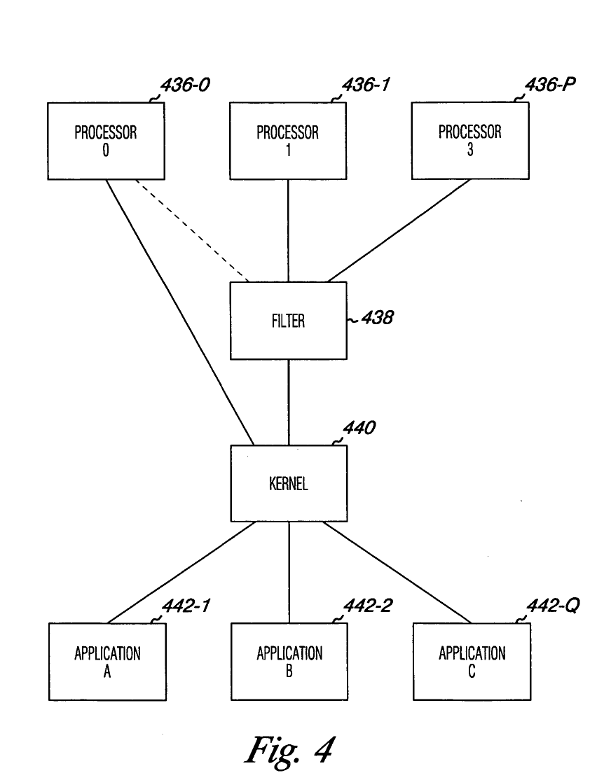

FIG. 4 illustrates an example of how streams of interrupts can be adjusted and passed between a number of processors and a number of application programs. FIG. 4 includes a number of processors 436-0, 436-1, and 436-P.

In the embodiment shown in FIG. 4, processor 436-0 has been designated as the first processor. Since the streams of interrupts of the first processor are the base for synchronizing the other streams of clock interrupts, streams of interrupts from the first processor can pass directly to the kernel 440. In such embodiments, the filter will be designed to count the interrupts in the stream passing to the kernel. However, in some embodiments, the streams of the first processor can also be directed through the filter 438.

The other streams of processors 436-1 and 436-P pass through the filter 438. The filter synchronizes the streams from 436-1 and 436-P with the stream of 436-0, as described herein. Those of ordinary skill in the art will appreciate from reading the present disclosure that the functionality of the filter can be provided by computer executable instructions within the kernel, the operating system, or a program application.

Computing device and system embodiments can adjust a stream of clock interrupts generated by the second processor such that the clock speed of the second processor is synchronized to the clock speed of the first processor. The computing systems and devices can include computer executable instructions to adjust the stream of clock interrupts generated by the second processor can include instructions to add a clock interrupt to a stream of clock interrupts generated by the second processor.

For example, computer executable instructions can insert a clock interrupt (e.g., tick) into the stream of clock interrupts generated by the second processor in order to synchronize the stream of clock interrupts associated with the second processor with the stream of clock interrupts associated with the first processor. In some embodiments, the device can also include computer executable instructions to remove a clock interrupt from a stream of clock interrupts generated by the second processor.

In various embodiments, the adjustment of the stream of clock interrupts of the second processor can include computer executable instructions for filtering the stream of clock interrupts of the second processor to correspond to a stream of clock interrupts of the first processor. The filtering of the stream of clock interrupts of the second processor can include adding a number of clock interrupts to the stream of clock interrupts of the second processor.

In some embodiments, the filtering of the stream of clock interrupts of the second processor can include removing a number of clock interrupts from the stream of clock interrupts of the second processor. The filtering of the stream of clock interrupts of the second processor can also include ignoring a number of interrupts within the stream of clock interrupts of the second processor. In this way, information is not discarded from the stream of interrupts, but rather the interrupts are ignored.

The filtering of a stream of interrupts can be accomplished, for example, by executing computer executable instructions to compare the stream of interrupts from the first processor to the stream of interrupts of another processor. When an interrupt of either stream cannot be matched, then an interrupt is either added, removed, or ignored.

For instance, if the stream of the second processor is missing an interrupt as compared with the stream of the first processor, then an interrupt can be added to the stream of the second processor. If the stream of the second processor has an interrupt where there is no interrupt when compared to the stream of the first processor, the interrupt can be either removed or ignored.

Further, interrupts and streams of interrupts can have a level of priority assigned thereto and as such, computer executable instructions can identify the priority and allow the individual interrupts or stream of interrupts to pass to the kernel unadjusted. This can be helpful in instances where an event has occurred that has to be handled as soon as possible.

Priorities can be set by inserting a flag into the data structure of the interrupt or stream of interrupts. Computer executable instructions in the kernel or the filter to identify the flag(s) and process the interrupts according to instructions associated with the flag. The instructions can be provided on the kernel or filter or can be provided with the interrupt or stream of interrupts.

The synchronization of the streams of clock interrupts and the identification of clock speeds can be accomplished at various times during operation of the computing device or system. For example, synchronizing the stream of clock interrupts can be accomplished before the clock interrupts in the stream are received by a clock handler, such as within the kernel. The identification of a clock speed for a first processor can be accomplished during a system boot process.

The identification of a clock speed for a processor can also be accomplished during runtime. For example, when a new processor becomes available, the clock speed information about the new processor can be obtained and the new processor can be synchronized to the first processor.

In various embodiments, the adjustment of the stream of clock interrupts generated by the second processor can include creating a data file containing a per processor count of a total number of clock interrupts delivered to an operating system since a last synchronization point and calculating an amount of adjustment based upon data in the data file containing the per processor count of the total number of clock interrupts. In some embodiments, the data in the data file containing the per processor count of a total number of clock interrupts can be reviewed periodically and the amount of adjustment recalculated based upon the review of the data.

Computer executable instructions can also be provided for detecting an interval timer interrupt within the stream of clock interrupts generated by the second processor and calculating an amount of adjustment based upon data in the data file containing the per processor count of the total number of clock interrupts. The calculation of the amount of adjustment based upon data in the data file containing the per processor count of the total number of clock interrupts can include comparing a total accumulated count of the second processor to a total accumulated count of the first processor. This information can be used to determine whether to discard the interval timer interrupt if the total accumulated count of the second processor is greater than the total accumulated count of the first processor, or to insert the interval timer interrupt if the total accumulated count of the second processor is less than the total accumulated count of the first processor.

In various embodiments, a data structure can be created that will contain the per processor count of the total number of clock ticks delivered to the operating system since a last synchronization point. After the processors have been started (e.g., during the boot), the interval timer frequencies of the running processors can be examined, the relative speed of the first processor (faster, slower, or equal) can be determined, and the counts can be synchronized.

Although specific embodiments have been illustrated and described herein, those of ordinary skill in the art will appreciate that any arrangement calculated to achieve the same techniques can be substituted for the specific embodiments shown. This disclosure is intended to cover adaptations or variations of various embodiments of the invention. It is to be understood that the above description has been made in an illustrative fashion, and not a restrictive one.

Combination of the above embodiments, and other embodiments not specifically described herein will be apparent to those of ordinary skill in the art upon reviewing the above description. The scope of the various embodiments of the invention includes various other applications in which the above structures and methods are used. Therefore, the scope of various embodiments of the invention should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A computing device, comprising:
a first processor;
a memory in communication with the first processor; and
computer executable instructions stored in memory and executable on the first processor to:
identify a clock speed for a first processor;
identify clock speed for a second processor; and
adjust a stream of clock interrupts generated by the second processor such that the clock speed of the second processor is synchronized to the clock speed of the first processor.

2. The computing device of claim 1, wherein the computer executable instructions to adjust the stream of clock interrupts generated by the second processor include adding a clock interrupt to a stream of clock interrupts generated by the second processor.

3. The computing device of claim 1, wherein the computer executable instructions to adjust the stream of clock interrupts generated by the second processor include removing a clock interrupt from a stream of clock interrupts generated by the second processor.

4. The computing device of claim 1, wherein the computer executable instructions to identify a clock speed for a first processor include accessing a data file having the clock speed of the first processor.

5. The computing device of claim 1, wherein the computer executable instructions to identify a clock speed for a second processor include accessing a data file having the clock speed of the second processor.

6. The computing device of claim 1, wherein the computer executable instructions to identify a clock speed for a second processor include accessing a data file having the clock speeds of a number of processors.

7. The computing device of claim 1, wherein the first processor is provided on a first computing device and the second processor is provided on another computing device.

8. A computing system, comprising:
a first processor;
a second processor; and
means for adjusting a stream of clock interrupts generated by the second processor such that a clock speed of the second processor is synchronized to a clock speed of the first processor.

9. The computing system of claim 8, wherein the means for adjusting the stream of clock interrupts of the second processor includes computer executable instructions for filtering the stream of clock interrupts of the second processor to correspond to a stream of clock interrupts of the first processor.

10. The computing system of claim 9, wherein the filtering of the stream of clock interrupts of the second processor includes adding a number of clock interrupts to the stream of clock interrupts of the second processor.

11. The computing system of claim 9, wherein the filtering of the stream of clock interrupts of the second processor includes removing a number of clock interrupts from the stream of clock interrupts of the second processor.

12. The computing system of claim 8, wherein the filtering of the stream of clock interrupts of the second processor includes ignoring a number of interrupts within the stream of clock interrupts of the second processor.

13. The computing system of claim 11, wherein the system includes computer executable instructions execute to store the clock speed of the first processor in memory.

14. A method for adjusting clock timing, comprising:
accessing a data file having a number of clock speeds for a number of processors therein;
identifying a clock speed for a first processor from the data file;
identifying clock speed for a second processor from the data file; and
adjusting a stream of clock interrupts generated by the second processor such that the second clock speed is synchronized to the clock speed of the first processor.

15. The method of claim 14, wherein adjusting the stream of clock interrupts generated by the second processor includes:
creating a data file containing a per processor count of a total number of clock interrupts delivered to an operating system since a last synchronization point; and
calculating an amount of adjustment based upon data in the data file containing the per processor count of the total number of clock interrupts.

16. The method of claim 15, wherein the method further includes:
periodically reviewing the data in the data file containing the per processor count of a total number of clock interrupts; and
recalculating the amount of adjustment based upon the review of the data.

17. The method of claim 14, wherein adjusting the stream of clock interrupts generated by the second processor includes:
creating a data file containing a per processor count of a total number of clock interrupts delivered to an operating system since a last synchronization point;
detecting an interval timer interrupt within the stream of clock interrupts generated by the second processor; and
calculating an amount of adjustment based upon data in the data file containing the per processor count of the total number of clock interrupts.

18. The method of claim 17, wherein calculating an amount of adjustment based upon data in the data file containing the per processor count of the total number of clock interrupts includes:
comparing a total accumulated count of the second processor to a total accumulated count of the first processor;
discarding the interval timer interrupt if the total accumulated count of the second processor is greater than the total accumulated count of the first processor; and
inserting the interval timer interrupt if the total accumulated count of the second processor is less than the total accumulated count of the first processor.

19. A method for adjusting clock timing, comprising:
identifying a clock speed for a first processor;
identifying clock speed for a second processor; and
adjusting a stream of clock interrupts generated by the second processor such that the clock speed of the second processor is synchronized to the clock speed of the first processor.

20. The method of claim 19, wherein adjusting the clock speed of the second processor includes filtering a stream of clock interrupts of the second processor to synchronize the stream of clock interrupts of the second processor to the stream of clock interrupts of the first processor.

21. The method of claim 20, wherein synchronizing the stream of clock interrupts is accomplished before the clock interrupts in the stream are received by a clock handler.

22. The method of claim 19, wherein identifying a clock speed for a first processor is accomplished during a system boot process.

23. The method of claim 19, wherein identifying a clock speed for a second processor is accomplished during a system boot process.

24. The method of claim 19, wherein the method further includes identifying a clock speed for a new processor during system runtime.

25. A computer readable medium having instructions for causing a device to perform a method, comprising:
identifying a clock speed for a first processor;
identifying clock speed for a second processor; and
adjusting a stream of clock interrupts generated by the second processor such that the clock speed of the second processor is synchronized to the clock speed of the first processor.

26. The computer readable medium of claim 25, wherein the method further includes:
identifying clock speed for a third processor; and
adjusting a stream of clock interrupts generated by the third processor such that the clock speed of the third processor is synchronized to the clock speed of the first processor.

27. The computer readable medium of claim 25, wherein identifying a clock speed for a first processor is accomplished by querying the first processor to identify the clock speed.

28. The computer readable medium of claim 25, wherein identifying a clock speed for a first processor is accomplished by receiving the clock speed from a first processor during a system boot process.

29. The computer readable medium of claim 25, wherein the method further includes selecting the first processor from a number of processors.
